(19) United States
(12) Patent Application Publication
(10) Pub. No.: US 2017/0298648 A1
(43) Pub. Date: Oct. 19, 2017

(54) FIVE SIDED OBELISK COLUMBARIUM

(71) Applicant: Eickhof Columbaria, Inc., Crookston, MN (US)

(72) Inventors: Paul M. Eickhof, Crookston, MN (US); Stephen Noyes, Brooklyn, NY (US); Hadi Sajadi, Eagan, MN (US); Thomas DeBoer, Crookston, MN (US); Peter Tollefson, Crookston, MN (US); David J. Trousil, Crookston, MN (US)

(21) Appl. No.: 15/491,820

(22) Filed: Apr. 19, 2017

Related U.S. Application Data
(60) Provisional application No. 62/324,730, filed on Apr. 19, 2016.

(51) Int. Cl. E04H 13/00; E04C 3/02; E04H 12/00; G09F 17/00

(52) U.S. Cl. CPC E04H 13/006; G09F 17/00; E04C 3/02; E04H 12/00

(57) ABSTRACT

A columbarium and ossuary system includes a five side columbarium. An obelisk like section includes a vertically extending central frame member. The central frame member has frame assemblies radiating outward from the central frame member. A plurality of niches are disposed about the central hub and supported by the hub. Each of the niches has an outer opening and sides abutting adjacent ones of the frame assemblies and converging from the outer opening towards the central hub. The lower section having a plurality of niches surrounding a center ossuary. A delivery chute is detachably mountable to the columbarium for pivoting to tilt the chute and deliver flexible urns to the ossuary.

### BACKGROUND OF THE INVENTION

### Field of the Invention

The present invention is directed to a non-rectangular obelisk style columbarium and in particular to a columbarium having an obelisk section and an ossuary with five sides.

### Description of the Prior Art

Cremation followed by inurnment has become an increasingly popular option over traditional burial. Inurnment provides for the use of smaller niches rather than full size crypts as a final resting place and for disposition of remains in a dignified manner. Columbaria in various shapes and sizes have been developed that have proven to be useful and adapted to a wide variety of location and needs.

However, due to the smaller size, niches have a smaller surface to personalize or memorialize information for the deceased and may limit the ability to include flags, symbols or other insignia on each niche. It can be appreciated that cemeteries for veterans could benefit from a columbarium that could recognize the military service of the deceased whose cremated remains are put to rest in the niches. The five branches of the U.S. military, the Army, Navy, Marines, Air Force and the Coast Guard are often recognized together. However, having five zones or sides of monuments or other memorials to recognize each of the five service branches has special design requirements as compared to more conventional rectangular or even round construction.

In addition to traditional niches, even lower cost options may still be desired such as an ossuary, with a single repository. An ossuary may still provide for a dignified interment of remains and provide a record of the individuals whose remains are inurned in the ossuary to indicate their final resting place. For respectful internment, a delivery system for depositing the cremated remains in a dignified is needed. Furthermore, it can be appreciated that a plaque or other memorial must be weather proof and long lasting. It can further be appreciated that such an ossuary may be specifically suited for the five service branches of the U.S. Military with a five sided monument.

It can therefore be seen that an improved inurnment system that provides for respectful delivery and permanent storage of cremated remains in a dignified and reverent manner is needed. Moreover, such a system may be suited for use at a veteran's cemetery or memorial and reflect the five service branches of the U.S. Military. Such a system may also be utilized with an ossuary and provide appropriate delivery and a record of the individuals' remains. The present invention addresses these as well as other problems associated with interment systems.

### SUMMARY OF THE INVENTION

A columbarium is configured in one embodiment with an obelisk mounted on a base. The obelisk forms individual niches that are covered with shutters attached with hardware that allows removal and replacement, as explained hereinafter. A sloped cap covers the top of the obelisk.

In the embodiment shown, the obelisk and the base each have five sides. It can be appreciated that should the columbarium be used to inurn remains for those in the military, each of the five sides may include a military branch insignia. Such an insignia may represent the five branches of the military, the army, marines, air force, navy and coast guard. It can also be appreciated that remains of service personnel may be placed in the niches corresponding to the insignia in the branch in which they served.

In the embodiment shown, the obelisk is five sided and a frame includes a center hub that is pentagon shaped and includes five framework trusses running vertically along each base of the hub and extending radially outward. The trusses form a pentagon shaped obelisk and define niches. The trusses provide for mounting the walls, floor and ceiling of the individual niches. Therefore, the niches of the obelisk have a generally triangular shape and narrow from the face of each niche towards the center hub. Each truss includes an inner vertical truss member and horizontal truss members extend outward from the vertical truss member. The horizontal members progressively decrease in length from the bottommost member to the topmost member to mirror the inward slant of the sides of the obelisk. An outer truss member slants slightly inward and forms the outermost side of each truss. Angled cross members extend upward and outward between horizontal truss members and between the inner truss member and outer truss member of each truss assembly. The trusses along with the center hub form a sturdy and rigid framework that achieves a pentagon shaped obelisk having a pleasant appearance. A flagpole may be included and is supported by a support assembly mounted at the top of the obelisk.

The obelisk frame is securely attached to the base with a mounting assembly. A vertical side plate and horizontal plate attach to the lowermost horizontal truss member and the outer truss member. Anchor rods extend through orifices in the horizontal plate and the horizontal plate to secure the obelisk columbarium to the base.

A second embodiment of the present invention includes a combined columbarium and ossuary unit. The columbarium includes an obelisk mounted onto a lower columbarium and ossuary unit.

The lower columbarium ossuary unit includes a cover, a vault and multiple niches dispersed around a periphery of the columbarium and ossuary unit. An ossuary cover section slants downward and outward from the bottom of the obelisk to the periphery of the lower columbarium ossuary unit. The cover section forms a memorial band with cover elements mounted at a slant between the bottom of the obelisk and the periphery of the lower unit. The bottom of the obelisk includes access niches that provide access to the ossuary vault.

Each of the niches includes shutters and mounting hardware. The niches also include side walls that extend toward one another from the front shutter to define niches having a triangular cross section for the niches in the obelisk. The niches in the combination ossuary and columbarium unit form substantially rectangular niches for the center portions of the sides of the unit while the niches at the corners of the five sided unit have a cross section narrowing from outer to inner sides. The mounting hardware is preferably hidden type hardware such as shown in U.S. Pat. Nos. 8,438,794 & 8,782,969.

The vault provides for disposal of cremated remains in a shared communal repository of the ossuary. Such communal inurnment provides for reduced costs while maintaining dignity and respect. Moreover, cremated remains inurned in such a manner may utilize flexible urns that provides for delivery to the vault while maintaining separation of the individual remains.

To deposit a flexible urn in the vault, access is provided through the access niches at the lower portion of the obelisk. The front shutter is removed from one of the access niches. The access niches have an opening bottom that provides for delivering the flexible urns into the vault area. A slide, chute or conveyor system may also be utilized to deliver the flexible urns into the vault. The vault is separate from the individual niches that are spaced about the periphery of the vault. It can be appreciated that the names for those whose final resting places are in the vault should have a dignified memorial. Names and other information may be placed on the cover elements. Moreover, other spaces for a memorial such as a band around the base or pavers or other ground markers around the columbarium and ossuary might also be utilized for such information. The vault may be configured as a single space or may be divided into five sections so that individuals of each military branch may share a respective communal repository.

These features of novelty and various other advantages that characterize the invention are pointed out with particularity in the claims annexed hereto and forming a part hereof. However, for a better understanding of the invention, its advantages, and the objects obtained by its use, reference should be made to the drawings that form a further part hereof, and to the accompanying descriptive matter, in which there is illustrated and described a preferred embodiment of the invention.

### BRIEF DESCRIPTION OF THE DRAWINGS

Referring now to the drawings, wherein like reference letters and numerals indicate corresponding structure throughout the several views:

FIG. 1 is an elevational view of a first embodiment of a five sided columbarium according to the principles of the present invention;

FIG. 2 is a top plan view of the five sided columbarium shown in FIG. 1;

FIG. 3 is a top plan view of a mounting assembly for the obelisk of the five sided columbarium shown in FIG. 1;

FIG. 4 is a top plan view of the framework for the five sided columbarium shown in FIG. 1;

FIG. 5 is a side elevational view of the framework shown in FIG. 4;

FIG. 6 is a side elevational view of a flag support for the framework shown in FIG. 5;

FIG. 7 is a top plan view of the flag support shown in FIG. 6;

FIG. 8 is a side elevational view of a base mount for the framework shown in FIG. 4;

FIG. 9 is a top plan view of the base mount shown in FIG. 8;

FIG. 10 is a side elevational view of a second embodiment of a five side columbarium including an ossuary according to the principles of the present invention;

FIG. 11 is a side sectional view of a framework for the columbarium shown in FIG. 10;

FIG. 12 is a top plan view of the columbarium shown in FIG. 10;

FIG. 13 is a first partial side sectional view of the columbarium and ossuary shown in FIG. 10;

FIG. 14 is a second partial side sectional view of the columbarium and ossuary shown in FIG. 10;

FIG. 15 is a detail view of lock hardware for a top row of niches for the columbarium shown in FIG. 10;

FIG. 16 is a detail view of lock hardware for a top center niche for the columbarium shown in FIG. 10;

FIG. 17 is a detail view of support hardware for bottom corner niches for the columbarium shown in FIG. 10;

FIG. 18 is a detail view of a base anchor and bracket for the columbarium shown in FIG. 10;

FIG. 19 is a detail view of a capstone anchor for the columbarium shown in FIG. 10;

FIG. 20 is a side elevational view of a flexible cremains container for use with the columbarium and ossuary system shown in FIG. 10;

FIG. 21 is a side sectional view taken along line 21-21 of FIG. 20;

FIG. 22 is a perspective view of a deliver chute assembly for the columbarium and ossuary shown in FIG. 10;

FIG. 23 is a side elevational view of the delivery chute assembly shown in FIG. 22;

FIG. 24 is an end elevational view of the delivery chute assembly shown in FIG. 22;

FIG. 25 is a partial side sectional view of the delivery chute assembly mounted to the columbarium and ossuary shown in FIG. 10;

FIG. 26 is a detail view of the delivery chute assembly mounting to the columbarium and ossuary shown in FIG. 25; and

FIG. 27 is a perspective view of a triangular urn for mounting in a niche of the obelisk columbarium shown in FIG. 1.

### DETAILED DESCRIPTION OF THE PREFERRED EMBODIMENT

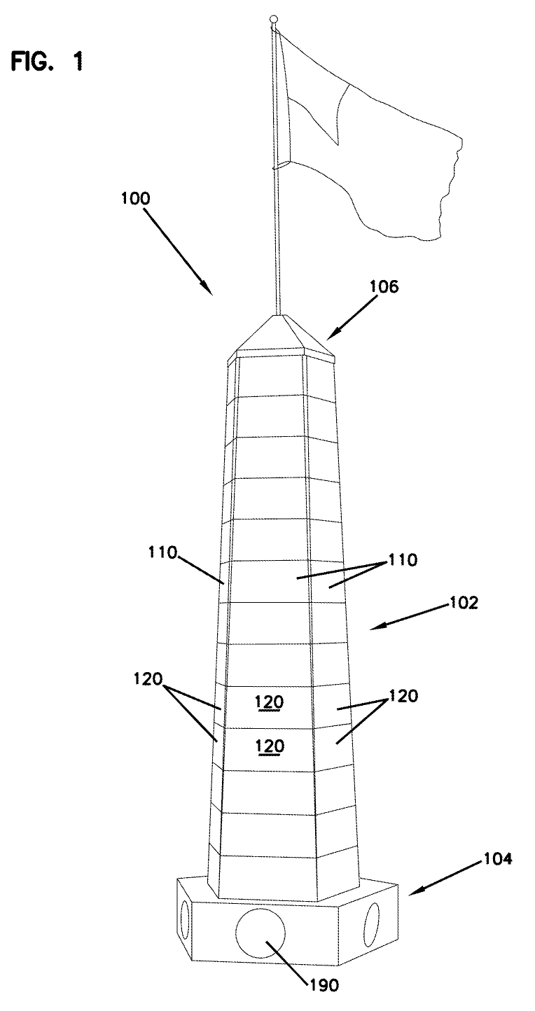

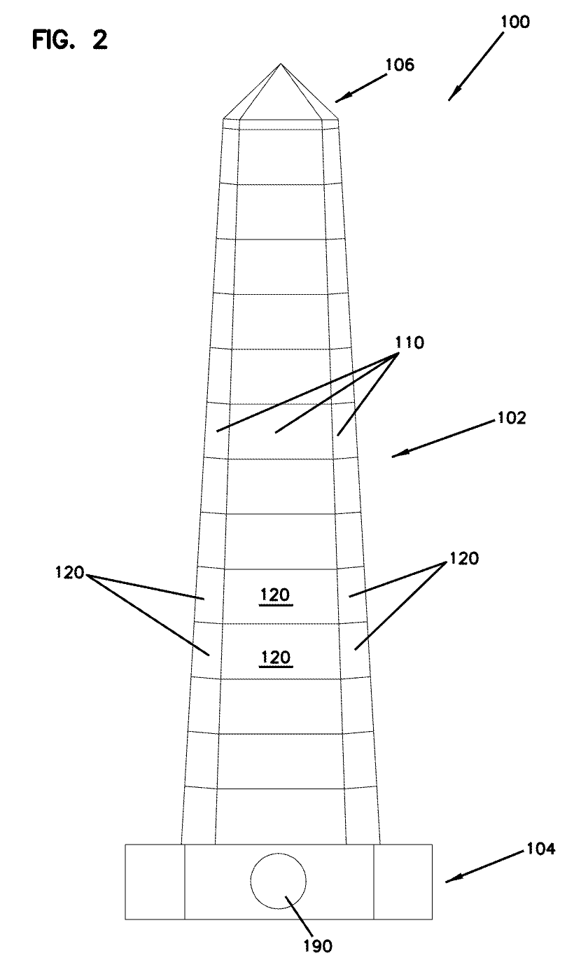

Referring now to the drawings and in particular to FIGS. 1 and 2, there is shown a first embodiment of an example columbarium, generally designated (100). The columbarium (100) is configured with an obelisk (102) mounted on a base (104). A sloped cap (106) is at the top of the obelisk (102). The obelisk (102) forms individual niches (110) that are covered with shutters (120), typically decorative stone shutters, held in place by hardware that allows removal and replacement, as explained hereinafter. Examples of such hidden shutter mounting hardware are shown for example in U.S. Pat. No. 8,438,794 and U.S. Pat. No. 8,782,969.

In the embodiment shown, the obelisk (102) and the base (104) each have five sides with a periphery formed as a pentagon. It can be appreciated that should the columbarium (100) be used to inurn remains for those in the military, each of the five sides may include a respective military branch insignia (190). Such an insignia may represent one of the five branches of the military, the army, marines, air force, navy and coast guard. It can also be appreciated that remains of service personnel may be placed in the niches (110) corresponding to the insignia of the branch in which they served.

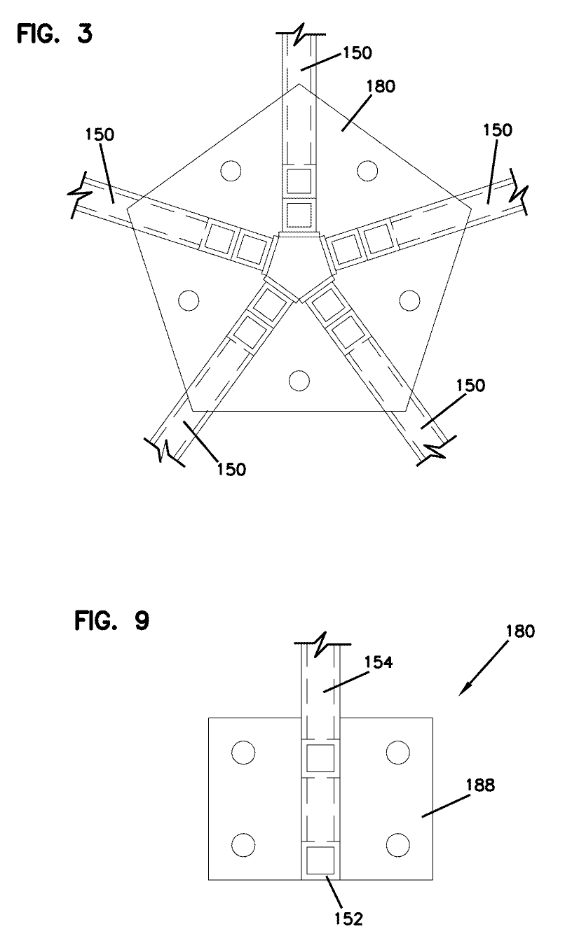

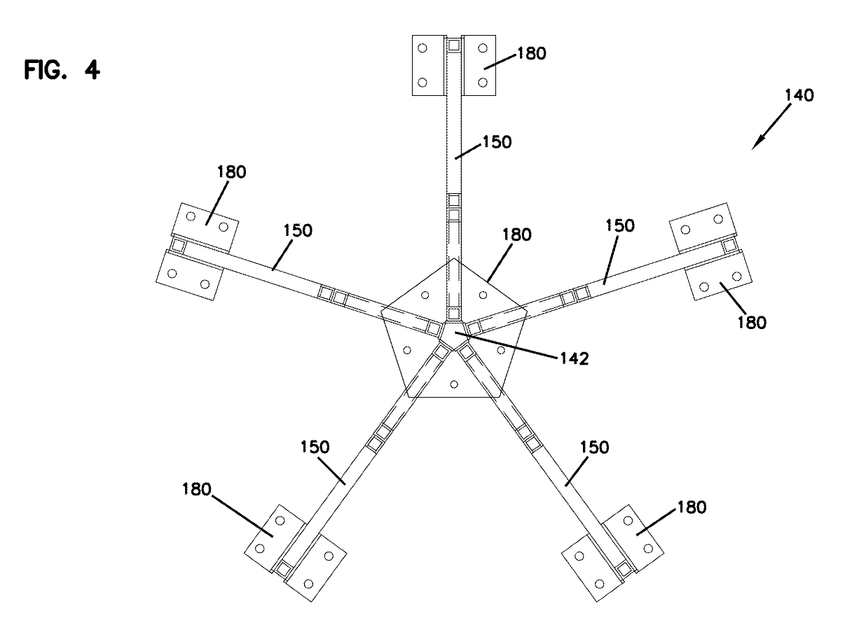

Referring now to FIGS. 3, 4 and 5, the obelisk columbarium (102) includes a frame (140). The obelisk (102) is five sided and the frame (140) includes a center hub (142) acting as a central spine that is pentagon shaped and includes five framework trusses (150) mounted along each face of the hub (142) and radiating outward in a star-like configuration. The trusses (150) form an obelisk frame and define five columns of individual niches (110) between the trusses (150). The trusses (150) provide for mounting the side walls (124) and shared floor and ceiling elements (126) of the niches (110), such as shown more clearly in FIG. 13. The niches (110) of the obelisk section (102) each have a generally triangular shape and narrow from the face of each niche (110) towards the center hub (142). Each truss (150) includes an inner vertical truss member (156). Horizontal truss members (154) extend outward from the vertical truss member (156). The horizontal members (154) progressively decrease in length from the bottommost member to the topmost member to mirror the slight inward taper of the sides of the obelisk. An outer truss member (152) slants slightly inward and forms the outermost side of each truss (150). Angled truss cross members (158) extend upward and outward between horizontal truss members (154) and between the inner truss member (156) and outer truss member (152). The trusses (150) along with the center frame hub (142) form a sturdy and rigid framework (140) that achieves a pentagon shaped obelisk having a pleasing appearance.

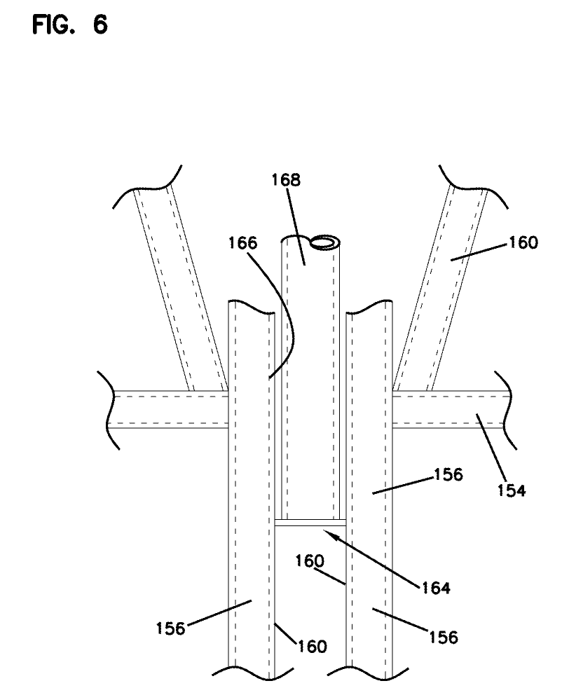

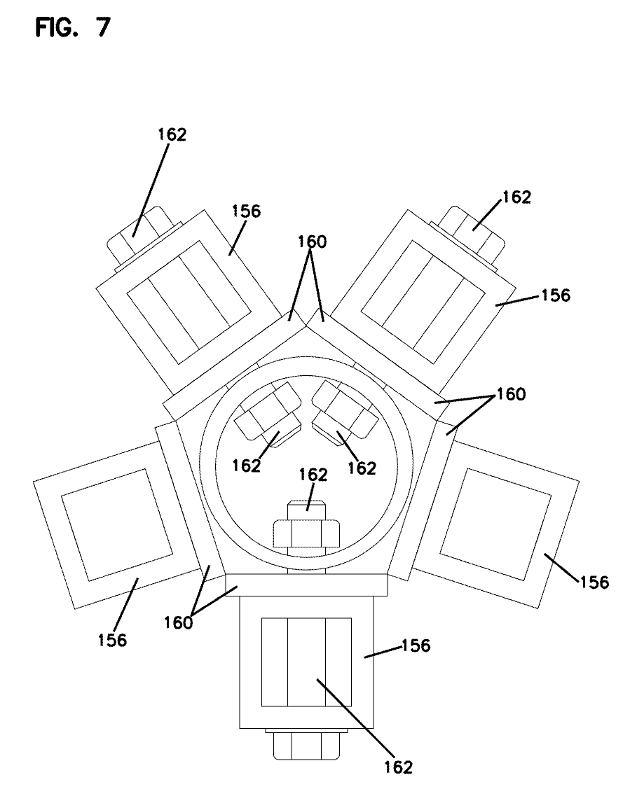

As shown in FIGS. 6 and 7, a flagpole (168) is held by a support assembly mounted at the top of the obelisk (102). The support assembly includes vertical plates (160) mounted to the inner vertical truss members (156). Mounting bolts (162) secure the flagpole to the truss members (156). A bearing plate (164) supports a lower end of the flagpole (168) as shown in FIG. 6. Welded together plates (166) form a socket with the bearing plate (164) that receives the bottom of the flagpole (168) and maintains the flagpole in a substantially vertical orientation.

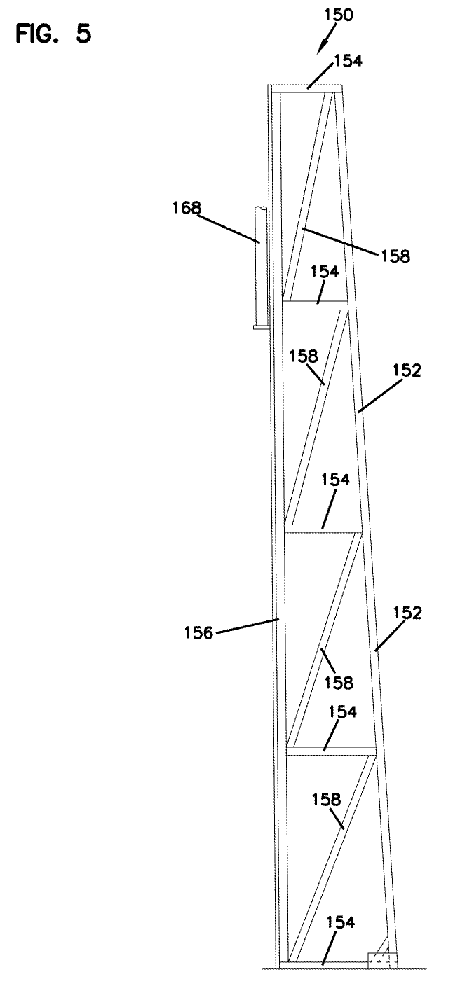

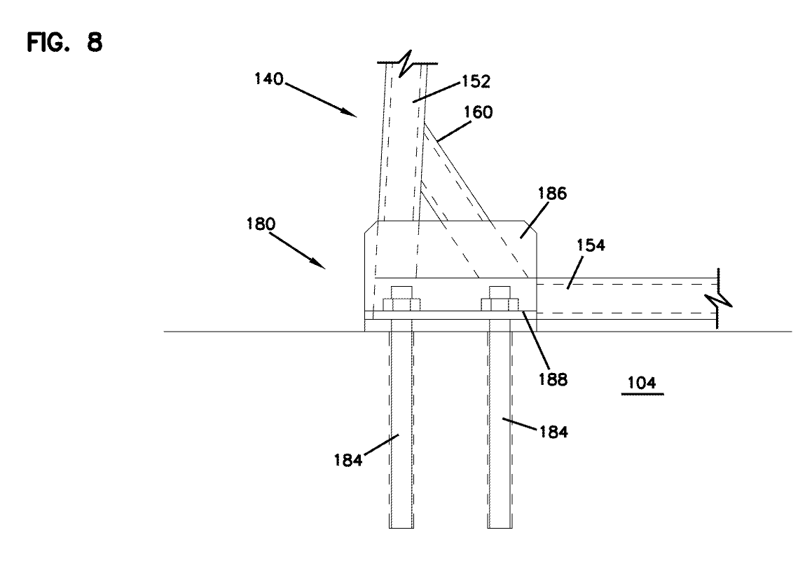

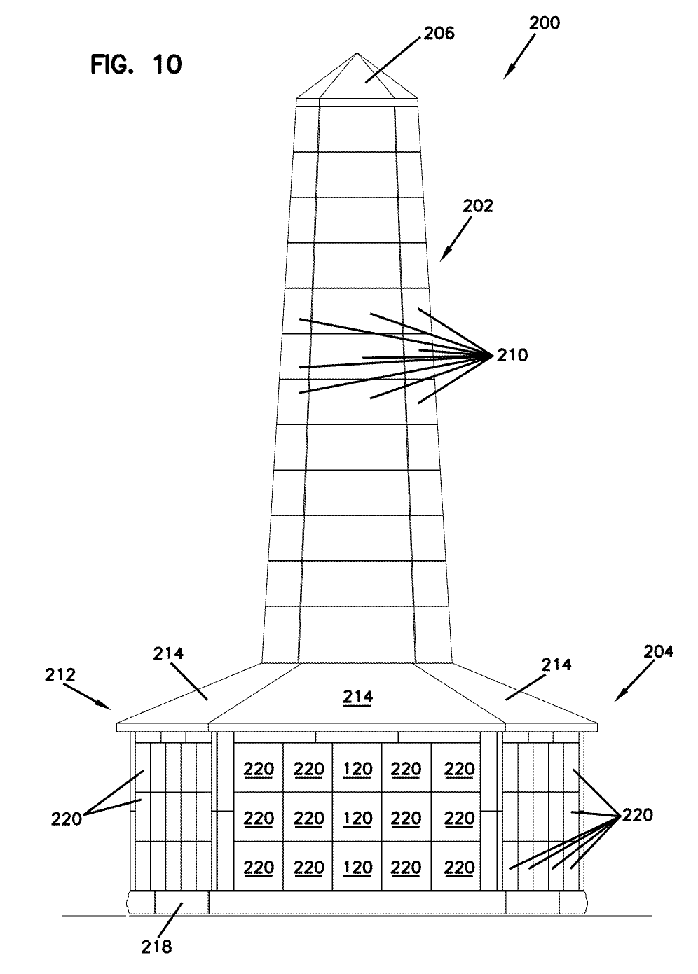

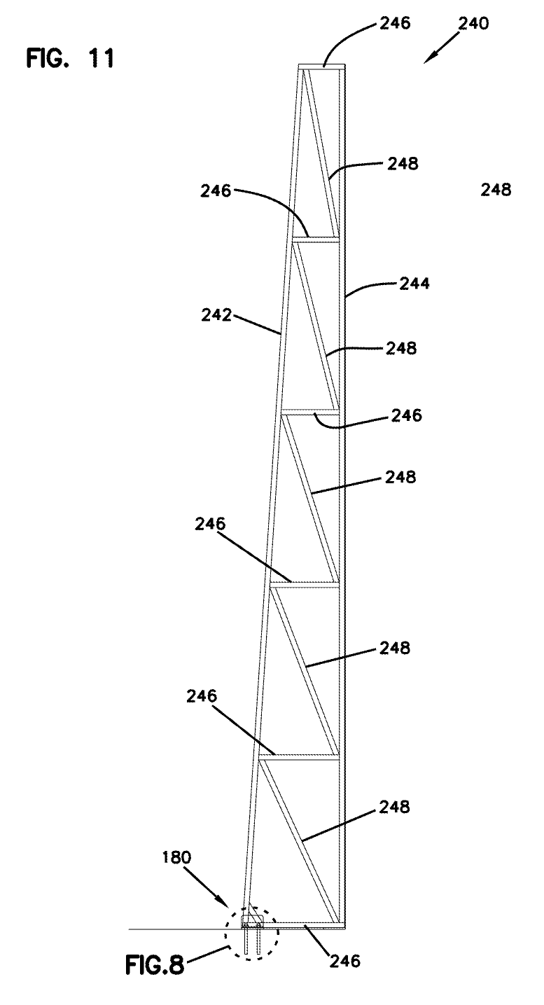

Referring now to FIGS. 5, 8 and 9, the obelisk frame (140) is securely attached to the base (104) with a mounting assembly (180). A vertical side plate (186) and horizontal plate (188) attach to the lowermost horizontal truss member (154) and the outer truss member (152). Anchor rods (184) extend through orifices in the horizontal plate (188) and the horizontal plate (188) to secure the obelisk columbarium (102) to the base (104).

As the niches (110) of the obelisk section (102) have a generally triangular shape and narrow from the face of each niche (110) towards the center, conventional cylindrical urns may be difficult to fit in the smaller cross-sections of uppermost tiers of niches (110). As shown in FIG. 27, urns (280) having a triangular cross-section may be utilized. The urn (280) has rectangular sides (282) and triangular ends (284). One of the sides (282) or ends (284) may act as a cover that may be opened to allow insertion of cremains into the urn (280). The triangular cross-section better matches the cross-section of the upper niches (110) so that the urn (280) has sufficient capacity for the cremated remains while still fitting into the niches (110).

Referring now to FIGS. 10-14, a second embodiment of the present invention includes a combined columbarium and ossuary system (200). The columbarium includes an obelisk (202) mounted onto a lower columbarium and ossuary unit (204). The obelisk (202) has a construction substantially similar to that shown in FIGS. 1-9.

The lower columbarium ossuary unit includes a cover (212), a vault (208) and multiple niches (220) dispersed around a periphery of the columbarium and ossuary unit (204). An ossuary cover section (212) slants downward and outward from the bottom of the obelisk (202) to the periphery of the lower columbarium and ossuary unit (204). The cover section (212) forms a surface that serves as a memorial band with cover elements (214) mounted at a downward and outward slant between the bottom of the obelisk and the periphery of the lower unit (204). The bottom of the obelisk (202) includes access niches (250) that provide access to the ossuary vault (208).

As with the embodiment for the obelisk (102) each of the niches (220) includes shutters (120) and mounting hardware (122). The niches (220) also include side walls (124) that extend toward one another from the front shutter to define niches having a triangular cross section for the niches in the obelisk (202). The niches (220) in the combination ossuary and columbarium unit (204) form substantially rectangular niches for the center portions of the sides of the unit (204) while the niches at the corners of the five sided unit (204) have a quadrilateral cross section narrowing from outer to inner sides. The mounting hardware (122) may be hidden type hardware such as shown in U.S. Pat. Nos. 8,438,794 and 8,782,969.

The vault (208) provides for disposal of cremated remains in a shared communal repository of the ossuary (204). Moreover, cremated remains inurned in such a manner may utilize a flexible urn (1000) that provides for delivery to the vault (208) while maintaining separation of the individual remains. Such communal inurnment provides for reduced costs while maintaining dignity and respect. The vault (208) may be a single repository space in which remains in flexible urns (1000) are received. If preferred, the vault (208) may include radially extending partition walls (222) that separate the vault (208) into five distinct chambers corresponding to each of the military branches. An outer vault wall (224) separates the niches (220) from the vault (208). The vault (208) may have a cast concrete construction or may be utilize weatherproof materials similar to that used for the niches. The configuration is generally adapted for the installation site and the particular application requirements.

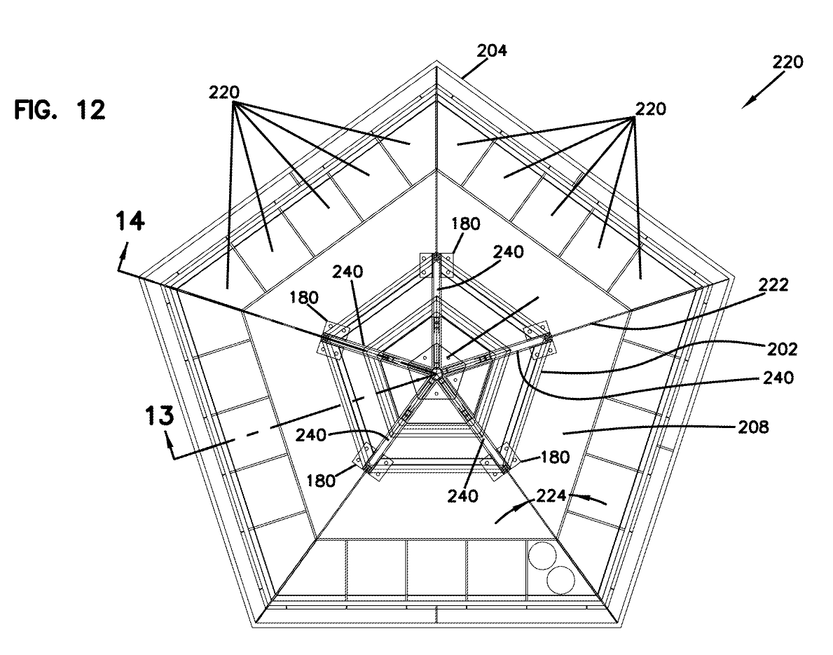

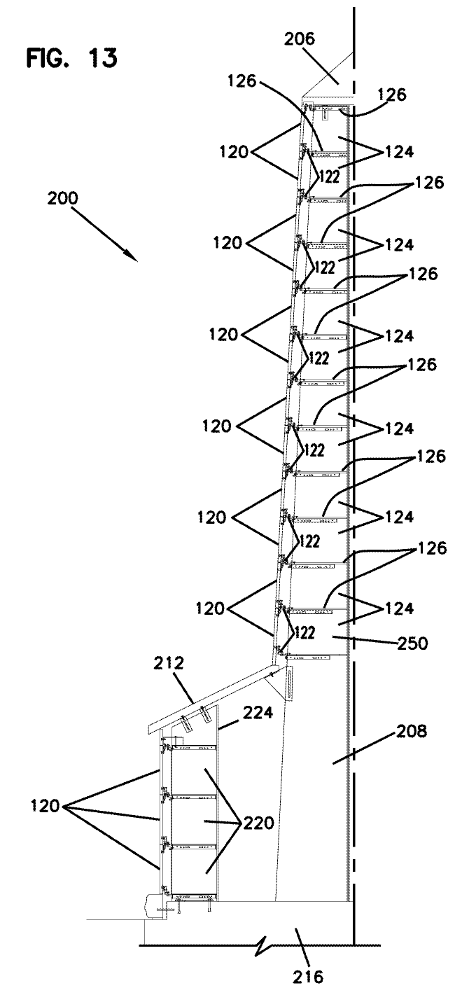

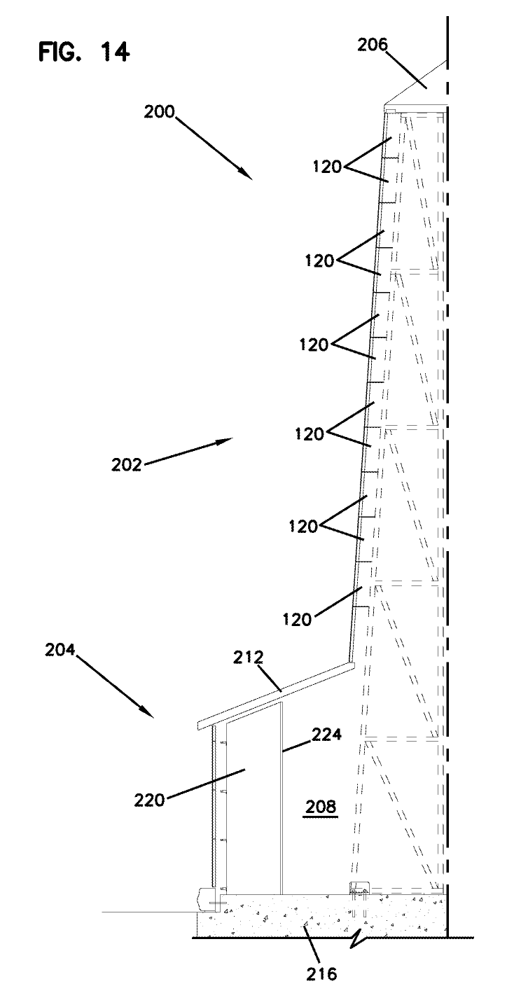

A framework is shown in FIG. 11 that extends substantially vertically from the obelisk (202) down through the ossuary (204) (as shown in phantom in FIG. 14). The framework includes five trusses (240) and positioned as at section line 14 of FIG. 12. Each truss (240) includes an outer slightly angled truss member (242), an inner truss member (244), horizontal truss members (246) and cross truss members (248).

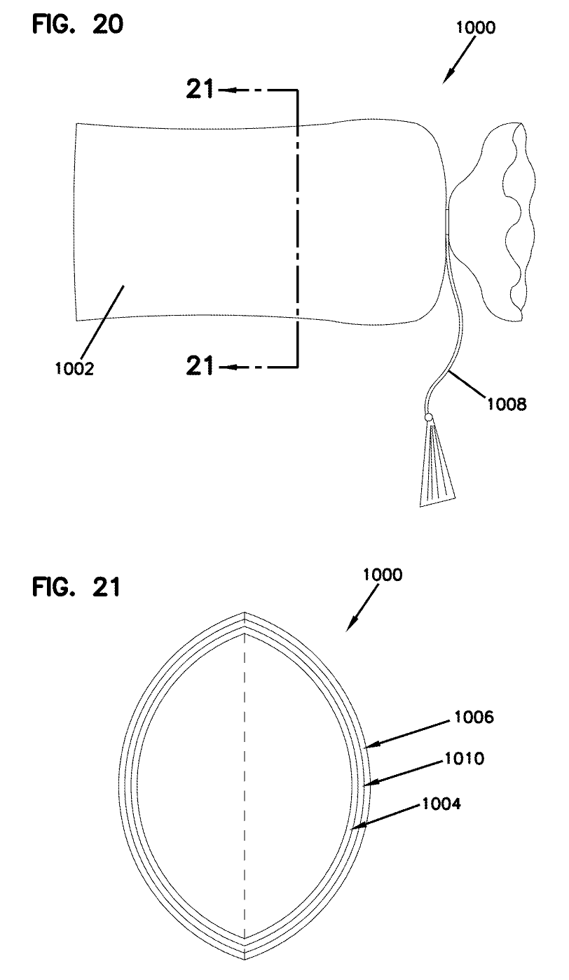

Referring now to FIGS. 20 and 21, the ossuary is specifically adapted for receiving flexible type urns (1000). The flexible urn (1000) includes a closable bag portion (1002). In a preferred embodiment, the bag portion (1002) includes an impermeable liner (1004) and an outer decorative layer (1006), as shown in FIG. 21. The outer decorative layer (1006) may also include an inner fabric liner (1010). The outer decorative layer (1006) may be made from satin, velvet or other appropriate fabrics providing a dignified appearance. Moreover, the outer layer (1006) may be embroidered and/or may include other graphics, such as religious symbols, as may be desired. The impermeable layer (1004) is sealed so that the cremated remains are safely contained within the impermeable liner (1004) of the bag (1002). A decorative cord or other closure (1008) closes the outer bag layer (1006) around the impermeable layer (1004) and provides protection of the impermeable layer (1004) to avoid tearing, puncture or other damage and prevents any cremated remains from escaping from the flexible-type urn (1000).

In one embodiment, to deposit a flexible urn (1000) containing remains in the vault (208), access is provided through one of the access niches (250) at the lower portion of the obelisk (202). The front shutter is removed from one of the access niches (250). The access niches (250) each have an opening in the bottom that provides for delivering the flexible urns (1000) into the vault area (208). The flexible urn (1000) may simply be placed in the access niche and then drops into the vault (208). As explained hereinafter, a slide or chute may also be utilized to deliver the flexible urns (1000) into the vault (208). The vault (208) is separate from the individual niches (220) that are spaced about the periphery of the vault (208), as shown for example in FIG. 13. It can be appreciated that the names for those whose remains are in the vault (208) should have a dignified memorial. Names and other information may be placed on the cover elements (214). Moreover, if additional space is needed, a band around the base (218) or pavers or other ground markers around the columbarium and ossuary system (200) might also be utilized for such information.

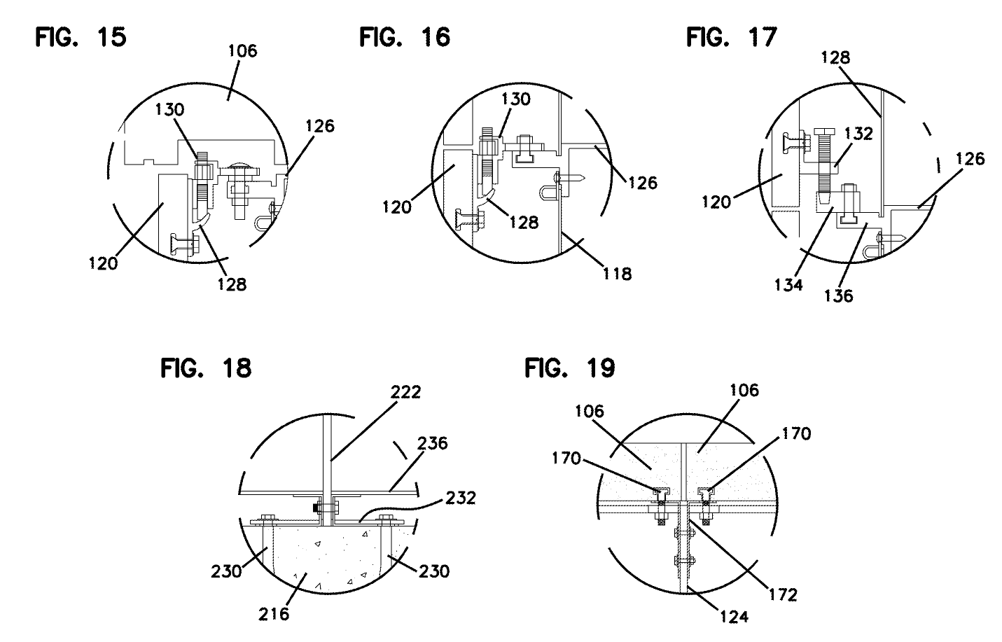

Referring now to FIGS. 15-19, the hardware for various cap stones and other exterior stonework is shown. The locking device and hardware for the top row of niches is shown in FIG. 15. The mounting hardware includes a lock clip (128) engaging a lock bracket (130). The lock bracket (130) mounts to the flange formed on the front of the shelf (126). The lock bracket (130) provides for adjustment with a rotatable set screw to adjust the position of the shutter relative to the position of the shutter.

Referring to FIG. 16, locking hardware (122) at the top center of niches also includes a lock set (128) and lock bracket (130) mounting to the shelf (126). An inner closeable panel (118) forms a further barrier for each niche. The shutters (120) are adjustable through the lock bracket.

Referring now to FIG. 17, the bottom corners of the niche front include a niche adjustment assembly (132) with an adjustable bolt that can engage a swivel socket (134) having a bolt engaging a shelf flange (136). The bolt of the niche adjuster provides for moving the position of the shutters (120) vertically while the swivel socket (134) provides for lateral positioning of the shutters (120).

Referring now to FIG. 18, the vertical vault partition walls (222) that may form subdivisions within the vault (208) are supported on a bracket (232). The bracket is engaged by anchors (230) that extend into the foundation (216). The vault partition wall (222) also accepts bottom shelves (236).

Referring to FIG. 19, the cap stone (106) is mounted with anchors (170) engaging brackets (172) that engage the walls (124) that divide the niches.

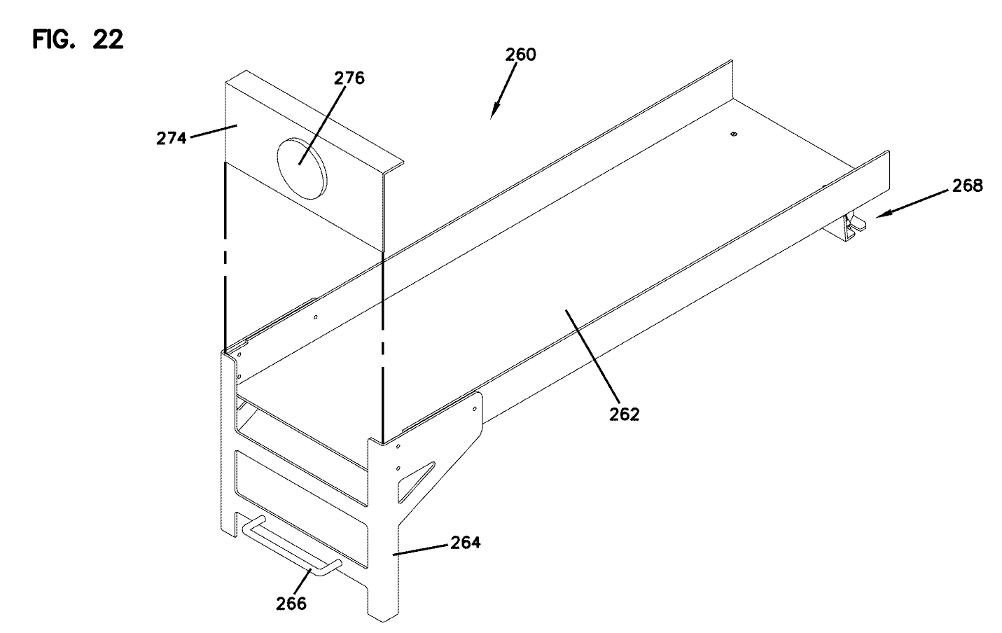

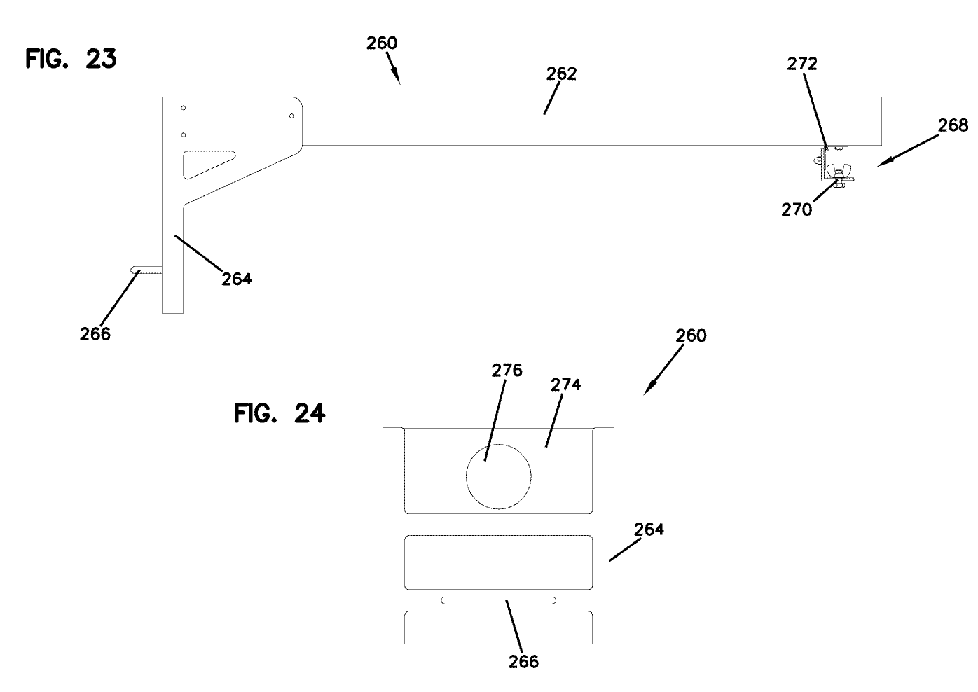

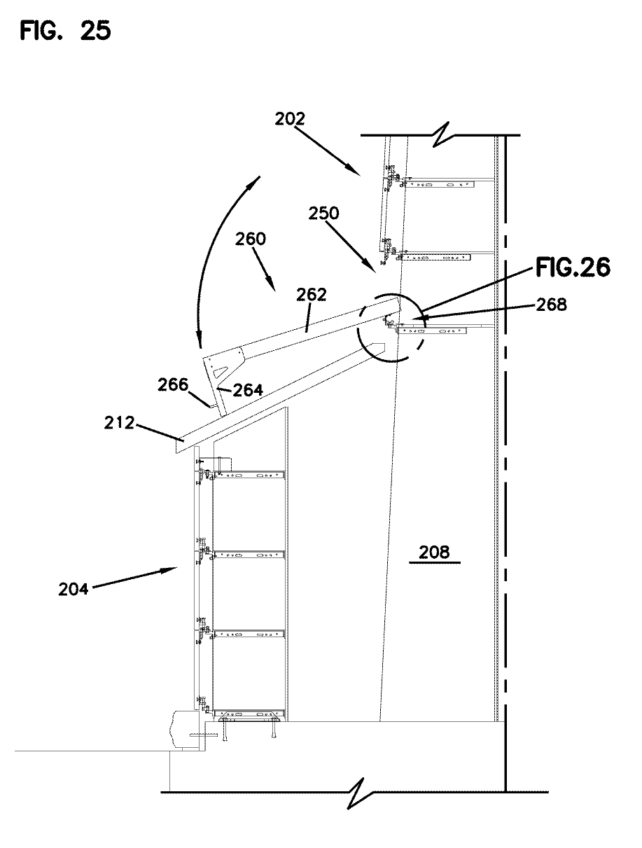

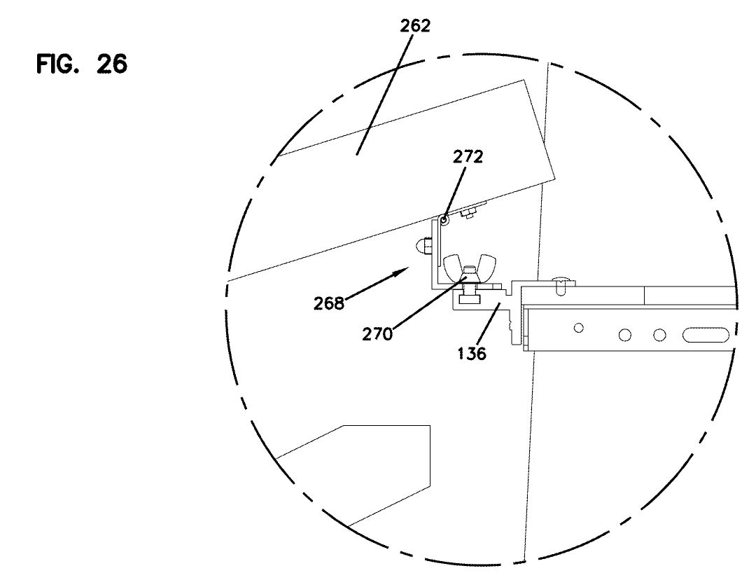

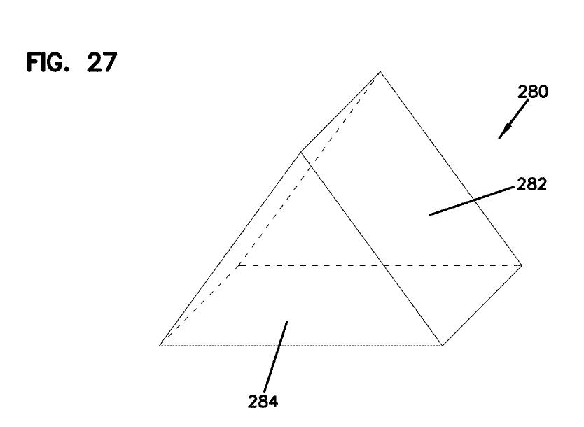

Referring now to FIGS. 22-25, there is shown a delivery system (260). The delivery system is configured to deliver the flexible urns (1000) to the ossuary vault (208). Rather than simply depositing flexible urns through an access niche, a delivery system that requires actuation by tilting up to allow a flexible urn to slide along a chute (262) may be utilized. Family and friends may participate in the actuation of delivery system (260), which may be preferred. The delivery system (260) includes the chute (262) that is removably attachable to the obelisk (202). The mounting assembly (268) removably attaches to the front shelf flange (136) when the shutter is removed to one of the access niches (250). A support (264) extends downward from the chute (262) and rests against the ossuary cover section (212). The delivery system also includes a handle ((266) on the support (264) for lifting the chute (262). The end of the chute (262) opposite the mounting assembly (268) includes an endwall (274) that holds a flexible urn in the chute (262) until the chute (262) is lifted upward and tilted to allow the flexible urn to slide down the chute (262). The endwall may include an insignia (276) such as a medallion and be interchangeable with other endwalls (274) having different insignia (276). For example the insignia could be for each of the five U.S. military service branches so that the correct insignia is used to match the particular section of the ossuary representing that branch. The mounting assembly includes a bolt assembly (270) including a bolt and nut that fit in a slot shelf flange (136). The mounting assembly could also include other mounting elements that provide for removably mounting the delivery system (260). A hinge (272) provide for rotating of the chute about a horizontal axis.

To deposit a flexible urn (1000) with the delivery system (260), the shutter (120) for an access niche (250) corresponding to the correct service branch is removed. The mounting assembly (268) is then attached to the shelf flange (136). The endwall (274) having the correct insignia (276) is slid into the end of the chute (262). The chute (262) may be lowered so that the support (264) rests on the ossuary cover (212). A flexible urn may then be placed at the end of the chute (262) against the endwall (274). When the flexible urn is to be delivered, the handle (266) is lifted and the chute (262) rotates about the hinge (272). When the chute (262) is at a sufficiently steep angle, the flexible urn will slide down the chute (262) and through the opening in the bottom of the access niche (250) and into the vault (208). The chute may then be lowered and the delivery system (260) may be removed so that the shutter (120) to the access niche (250) may be replaced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A columbarium, comprising:
a vertically extending central frame member;
frame assemblies extending outward from the central frame member;
a plurality of niches disposed about the central hub and supported by the hub, each of the niches having an outer opening and sides abutting adjacent ones of the frame assemblies and converging from the outer opening towards the central hub.

2. A columbarium according to claim 1, further comprising a plurality of radially extending frame elements mounted to the hub.

3. A columbarium according to claim 1, wherein the columbarium comprises five sides.

4. A columbarium according to claim 1, wherein the columbarium includes five columns of the niches disposed about the central hub.

5. A columbarium according to claim 1, wherein the columbarium comprises a plurality of levels of the niches.

6. A columbarium according to claim 1, wherein the columbarium comprises a plurality of levels of the niches, wherein niches of different ones of the plurality of levels of niches are aligned vertically with niches of adjacent levels.

7. A columbarium and ossuary system, comprising:
an upper section including a vertically extending central frame member;
frame assemblies extending outward from the central frame member;
a plurality of niches disposed about the central hub and supported by the hub, each of the niches having an outer opening and sides abutting adjacent ones of the frame assemblies and converging from the outer opening towards the central hub.
a lower section having a plurality of niches surrounding a center ossuary.

8. A columbarium according to claim 7, wherein the tower configuration comprises an obelisk.

9. A columbarium according to claim 7, wherein the columbarium comprises five sides.

10. A columbarium according to claim 7, further comprising an access niche leading to the ossuary.

12. A columbarium according to claim 7, wherein the upper section comprises an obelisk.

13. A columbarium according to claim 7, wherein the upper section comprises a delivery system to the ossuary.

14. A columbarium according to claim 7, further comprising a flag pole support

15. A columbarium according to claim 7, wherein the center ossuary comprises a plurality of partition walls separating the ossuary into a plurality of distinct chambers.

16. A columbarium according to claim 15, wherein the upper section comprises five columns of niches and the ossuary of the lower section comprises five chambers.

17. An ossuary delivery system comprising:
a removable shutter element mounted to an ossuary with shutter mounting hardware attached to the ossuary and complementary shutter mounting hardware attached to the removable shutter;
a chute assembly, the chute assembly comprising:
a chute portion attached to the mounting element;
a mounting portion mountable to the shutter mounting hardware with the chute portion being pivotable relative to the ossuary about a substantially horizontal rotational axis.

18. An ossuary delivery system according to claim 17, wherein the mounting portion comprises a bolt and nut.

19. An ossuary delivery system according to claim 17, wherein the shutter mounting hardware attached to the ossuary defines a slot.

20. An ossuary delivery system according to claim 19, wherein the mounting portion comprises a bolt engaging the slot.

21. An ossuary delivery system according to claim 17, further comprising an insignia plate mounted to the chute portion.

22. An ossuary delivery system according to claim 17, further comprising interchangeable insignia plates mounted to the chute portion, each of the interchangeable insignia plates have a discrete insignia.

23. An ossuary delivery system according to claim 17, further comprising a handle mounted to the chute portion spaced apart from the mounting portion.

24. An ossuary delivery system according to claim 17, further comprising a support spaced apart from the mounting portion and configured to engage the ossuary prior to lifting.
